(19) United States
(12) Patent Application Publication
(10) Pub. No.: US 2008/0034146 A1
(43) Pub. Date: Feb. 7, 2008

(54) Systems and Methods for Transactions Between Processor and Memory

(75) Inventors: Richard Duncan, Bedford, TX (US); William V. Miller, Arlington, TX (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Hsin-Tien (TW)

(21) Appl. No.: 11/462,490

(22) Filed: Aug. 4, 2006

(51) Int. Cl. G06F 13/36

(52) U.S. Cl. 710/309; 710/113

(57) ABSTRACT

Circuits for improving efficiency and performance of processor-memory transactions are disclosed. One such system includes a processor having a first bus interface unit and a second bus interface unit. The processor can initiate more than one concurrent pending transaction with a memory. Also disclosed are methods for incorporating or utilizing the disclosed circuits.

### TECHNICAL FIELD

The present invention is generally related to computer hardware and, more particularly, is related to a systems, apparatuses, and methods for communication among a computer processor and other components on a system bus.

### BACKGROUND OF THE INVENTION

Processors (e.g., microprocessors) are well known and used in a wide variety of products and applications, from desktop computers to portable electronic devices, such as cellular phones and PDAs (personal digital assistants). Many processor architectures employ a pipelining architecture, which, as is known in the art, separates various stages of processor operation so that a processor can work on the execution of more than one operation at any one time. As a non-limiting example, processors often separate the fetching and loading of an instruction from the execution of the instruction so that the processor may work on the execution of an instruction while simultaneously fetching the next instruction to be executed from memory. Pipelining architectures are used to increase the throughput of a processor when measured in terms of executed instructions per clock cycle. Various stages of a processor's pipeline often require access to a computer's memory to either read or write data, depending on the stage and the current processor instruction.

As is pictured in an exemplary representation of a computer system in FIG. 1, computer systems typically employ a system bus 108 that facilitates communication between the various components of the system, such as, the processor 102, the memory 110, peripherals and other components. Components are generally coupled to the system bus 108 and communicate with the system bus and other components via a bus interface unit. Such components, which can also be referred to as bus masters, can request access to the system bus 108. The system bus 108, through a system bus arbiter 114, grants access to the system bus 108 to a requesting bus master when the system bus arbiter 114 determines it is appropriate. The system bus arbiter 114 can determine when it is appropriate to grant access to the system bus 108 depending on a number of factors, including but not limited to: whether the system bus is currently in use by another bus master or whether the request is deemed to be a high-priority request. It is also known in the art that systems and methods (other than the use of a system bus arbiter) can be used to arbitrate access to a computer system's system bus.

An exemplary processor pipeline, which is also known in the art as a core pipeline, requires communication with a computer system's memory in order to fetch instructions and perform other interactions with a memory, such as, accessing data residing in memory or writing to memory. As depicted in FIG. 2, a processor 202 can perform memory interactions by communicating requests to a cache or buffer, which forward a request to the memory 210 through a bus interface unit 224. The processor's bus interface unit 224 can communicate with a memory 210 via the system bus 208, when the system bus arbiter 214 determines that the processor 202 and its bus interface unit 224 should be granted access to the system bus 208.

FIG. 3 depicts an exemplary core pipeline 316 in more detail and an exemplary configuration with a bus interface unit 324. The pipeline's stages require interaction with the memory 310 if, for example, instruction cache 318 cannot deliver the appropriate requested instruction to the fetch pipeline stage 328 or data cache 320 cannot deliver the appropriate requested memory data to the memory access pipeline stage 334. In this exemplary depiction, memory-access pipeline stage 334 can submit a request to write data to the memory 310 via data cache 320. In the configuration shown in FIG. 3, the various stages of the core pipeline 316 interact with the system bus 308 and the memory 310 by communicating requests through a single bus interface unit 324, which requests access to the system bus 308 from the system bus arbiter 314, and subsequently communicates the request to the memory 310.

One disadvantage of the computer system configuration depicted in FIGS. 2 and 3 is that all core pipeline transactions with a memory 310 or other system bus peripherals 312 must be performed via a single bus interface unit 324. If in the fetch pipeline stage the instruction cache does not contain the requested instruction and must retrieve it from the memory, for example, the fetch stage may stall for a larger number of clock cycles than if the instruction cache contained the requested instruction and could service the request itself. This stalling will delay the fetch pipeline stage from completing and prevent it from moving to the next instruction. This stalling will also cause downstream stages of the core pipeline to incur delay. Downstream stages of the core pipeline requiring a transaction with the memory or another component on the system bus will often be stalled if the system bus specification does not allow a processor bus interface unit to engage in more than one simultaneous transaction. This is a characteristic of, for example, a system bus conforming to the Advanced High-Performance Bus (AHB) specification and other types of system bus specifications which are known in the art.

The AHB specification allows for system bus masters such as a processor to engage in split transactions with a memory. In other words, it allows a bus interface unit, for example, to acquire access to the system bus, send a request on the system bus and relinquish its access to the system bus before the transaction is completed. This allows other bus masters to perform other operations involving the system bus or initiate other transactions while the request is being serviced. When the request is ready to be completed, the bus interface unit regains access to the system bus to complete the transaction. As mentioned above, while the AHB specification and other system bus specifications allow bus masters to engage in split transactions, it does not allow a bus master to engage in more than one concurrent split transaction with a memory.

In the exemplary computer system configurations (FIGS. 2 and 3), this above mentioned characteristic of the system bus combined with the configuration of the processor and core pipeline create conditions where less than ideal performance results. FIG. 4 illustrates some of the signals on the system bus originating from the bus interface unit of the processor and a memory controller, which can handle communications with the system bus and other bus masters, of the memory. Because only one split transaction is permitted by the system bus specification for each bus interface unit, the memory can be in an idle state while awaiting a next request from a core pipeline stage. This idle time demonstrates inefficiencies in the core pipeline, which if reduced would result in increased performance and efficiency of the computer system. Thus, a heretofore unaddressed need exists in the industry to address the aforementioned deficiencies and inadequacies.

### SUMMARY

Included herein are systems and methods for improving the performance of a computer system by optimizing memory transactions between a computer processor and a memory via a system bus. The systems may include a computer processor having a first processor bus interface unit in communication with a system bus and a second processor bus interface unit in communication with the system bus. Also included is a memory system, the memory system in communication with the system bus. The first processor bus interface unit and the second processor bus interface unit are configured to submit requests to the memory system and the memory system is configured to service a first request from a processor bus interface unit and begin the servicing of a second request from a processor bus interface unit before completing the servicing of the first request.

The systems may also include a computer processor configured with a core pipeline having at least an instruction fetch stage, a data access stage and a data write-back stage. Also included is a first bus interface unit configured to fetch instructions from a memory system for the instruction fetch stage and a second bus interface unit configured to access the memory system for the data access stage.

The methods may include submitting a first request to the system bus via a first processor bus interface unit and submitting a second request to the system bus via a second processor bus interface unit.

### BRIEF DESCRIPTION OF THE DRAWINGS

FIG. 1 is a functional block diagram illustrating various bus masters, peripherals, and a memory system coupled to a system bus, as is known in the prior art.

FIG. 2 is a functional block diagram of a system bus coupled to bus masters, peripherals, and a memory system with an exploded view of a processor, as is known in the prior art.

FIG. 3 is a functional block diagram of a system bus coupled to bus masters, peripherals, and a memory system with an exploded view of a processor and the processor's core pipeline, as is known in the prior art.

FIG. 4 is a timing diagram depicting the interactions of a processor with a bus interface unit coupled to a system bus and a memory coupled to the system bus, as is known in the prior art.

FIG. 5 is a functional block diagram of an embodiment in accordance with the disclosure.

FIG. 6 is a functional block diagram of an embodiment in accordance with the disclosure depicting an exploded view of a processor and the core pipeline.

FIG. 7 is a functional block diagram of an embodiment in accordance with the disclosure.

FIG. 8 is a timing diagram of an embodiment in accordance with the disclosure.

### DETAILED DESCRIPTION

The present disclosure generally relates to a computer system and, more specifically, a computer processor having improved system bus communication capabilities. In accordance with one embodiment, a system comprises a computer processor with a first processor bus interface unit and a second processor bus interface unit coupled to a system bus. The first processor bus interface unit makes requests to the memory via the system bus to support instruction fetches, and the second processor bus interface unit makes requests to the memory system and peripherals to support data accesses. In computer systems comprising a system bus specification that does not allow more than one split transaction for any one bus master, such as the Advanced High-Performance Bus (AHB) specification, the first and second processor bus interface units allow the computer processor to initiate a first split transaction on behalf of a first core pipeline stage and initiate a second split transaction on behalf of a second core pipeline stage regardless of whether the first split transaction has completed.

As is known in the art, a core pipeline can stall if, for example, a fetch stage requires a memory access in order to complete an instruction fetch, a data access being an operation that may require more clock cycles to complete than if the requested instruction resides in the processor's instruction cache. A potential effect of this stalling is that a downstream core pipeline stage, such as the data-access pipeline stage, is also prevented from submitting a request to the memory system or peripherals if the fetch stage has submitted a request because a system bus specification disallowing multiple split transactions from a single bus master would prevent it. In this situation, the data-access stage must wait until the completion of a request to the memory system made on behalf of the fetch pipeline stage. This aforementioned situation can cause additional stalling of the core pipeline and reduced performance of the processor.

An embodiment in accordance with the disclosure can reduce the effect of core pipeline stalling on the performance of the computer system. By allowing the processor to submit more than one simultaneously pending request to a memory system or other component on the system bus, the effect of core pipeline stalling is reduced.

Other systems, methods, features, and/or advantages will be or may become apparent to one with skill in the art upon examination of the following drawings and detailed description. It is intended that all such additional systems, methods, features and/or advantages be included within this description and be protected by the accompanying claims.

Having summarized various aspects of the present disclosure, reference will now be made in detail to the description as illustrated in the drawings. While the disclosure will be described in connection with these drawings, there is no intent to limit it to the embodiment or embodiments disclosed therein. On the contrary, the intent is to cover all alternatives, modifications, and equivalents included within the spirit and scope of this disclosure as defined by the appended claims. It should be emphasized that many variations and modifications may be made to the above-described embodiments. All such modifications and variations are intended to be included herein within the scope of this disclosure and protected by the claims following this disclosure.

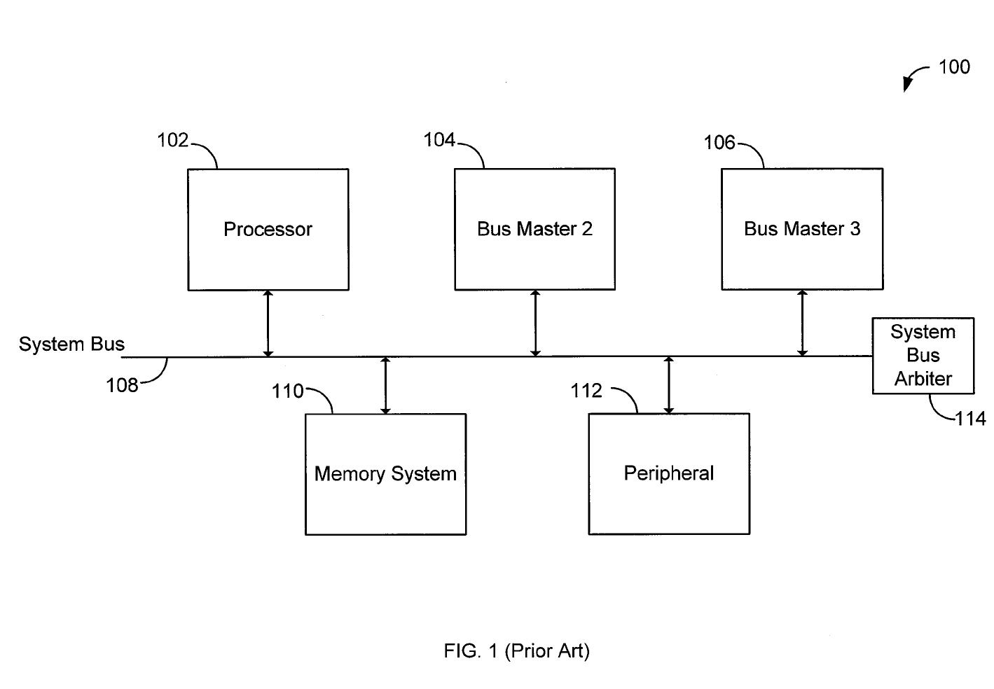

FIG. 1 represents a framework known in the art for arranging components of a computer system 100. The processor 102, memory system 110, other bus masters 106, 110, peripherals 112 and system bus arbiter 114 are coupled to a system bus 108 through which the components of the computer system 100 can communicate. A bus master is known in the art as a component of a computer system residing on the system bus 108 and utilizing the system bus 108 for communicating with other devices residing on the system bus 108. The system bus 108 can represent a bus in conformance with various specifications including but not limited to: the Advanced High-Performance Bus (AHB). The system bus arbiter 114 determines which component should have access to the system bus 108, and it also determines when a component should transfer data to or from the system bus 108.

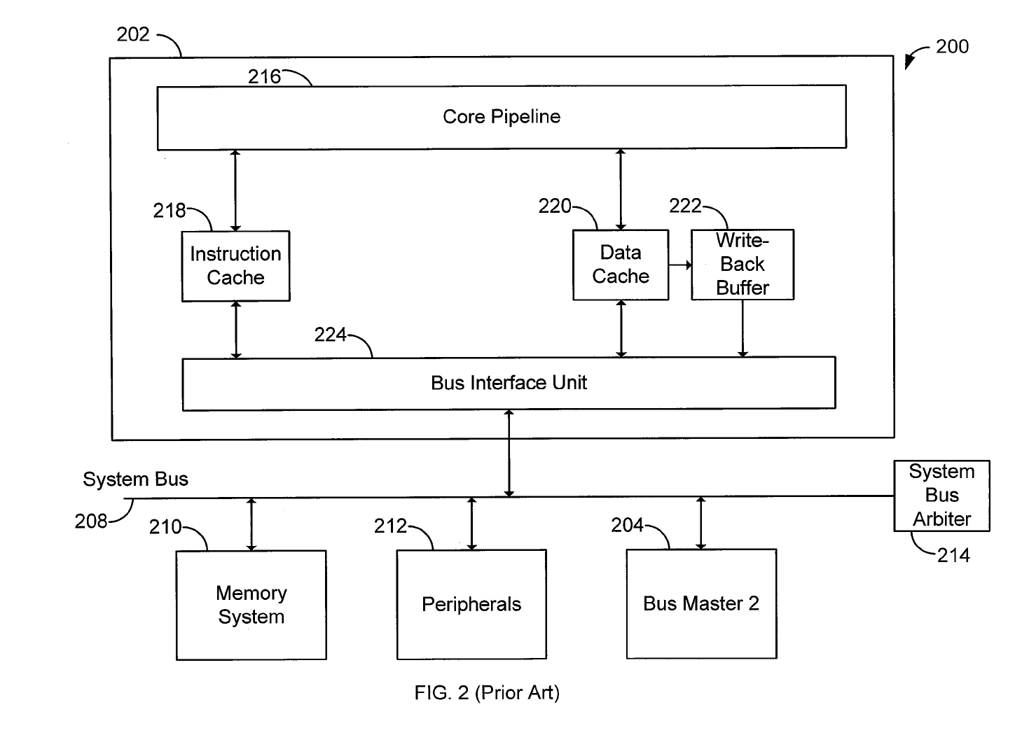

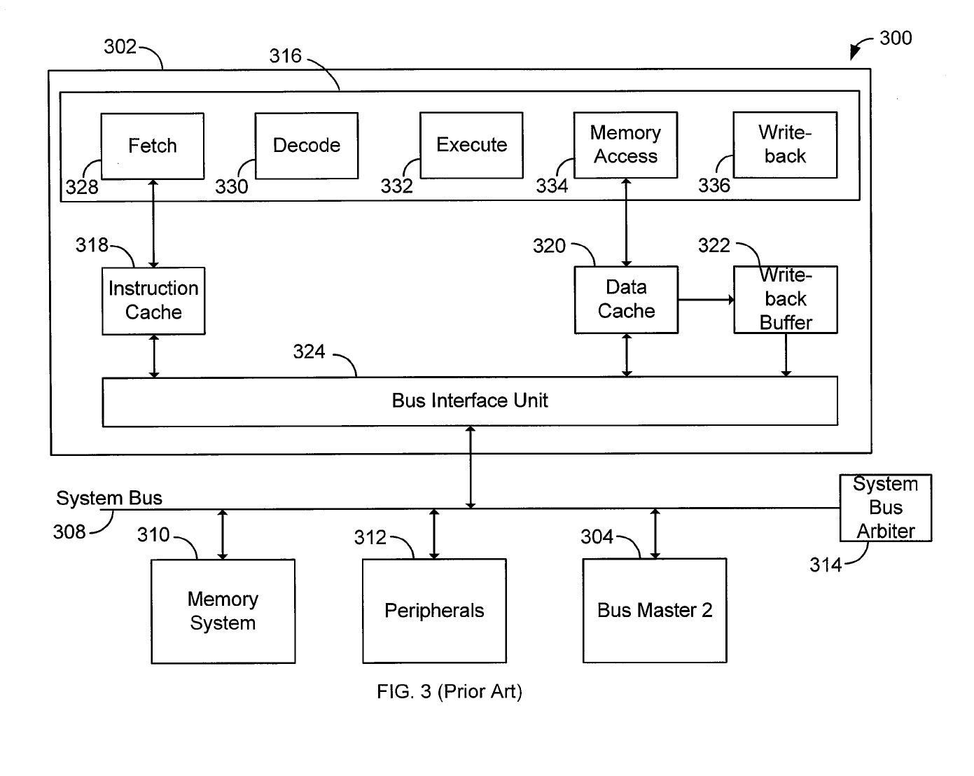

FIG. 2 depicts an exploded view of a processor 202. As is known in the prior art, the processor 202 communicates with the system bus 208 via a bus interface unit 224. The core pipeline 216 can submit a request for data retrieval or a request to write data to a memory system 210. In the exemplary depiction, an instruction cache 218, a data cache 220 and a write-back buffer 222 service a request of a core pipeline 216 stage, which may be relayed to the memory system 210 via the bus interface unit 224 if necessary. FIG. 3 includes an exploded view of the processor's core pipeline 316. If the fetch pipeline stage 328 requests an instruction from the instruction cache 318, the instruction cache 318 will either deliver the instruction if it is contained in the instruction cache 318 or submit a request to the memory system 310 via the bus interface unit 324 and the system bus 308 to retrieve the instruction and then deliver the retrieved instruction to the fetch pipeline stage 328. Similarly, if the memory-access pipeline stage 334 requests data from the data cache 320, the data cache 320 will either deliver the requested data to the memory-access pipeline stage 334 if it is contained in the data cache 320 or submit a request to the memory system 310 or peripherals 312 via the bus interface unit 324 and the system bus 308 to retrieve the data and then deliver the data to the memory-access pipeline stage 334. In the depicted example, if the memory-access pipeline stage 334 requests to write data to the memory system 310 or peripherals 312, the data cache 320 will determine whether it will immediately send the request on to its destination via the bus interface unit 324 and system bus 308 or post the data into the write-back buffer 322. If the data is posted to the write-back buffer 322, then the data will be stored in the write-back buffer 322 until higher priority requests are serviced; then the write-back buffer 322 will write the data to the memory system 310 through the bus interface unit 324 and system bus 308.

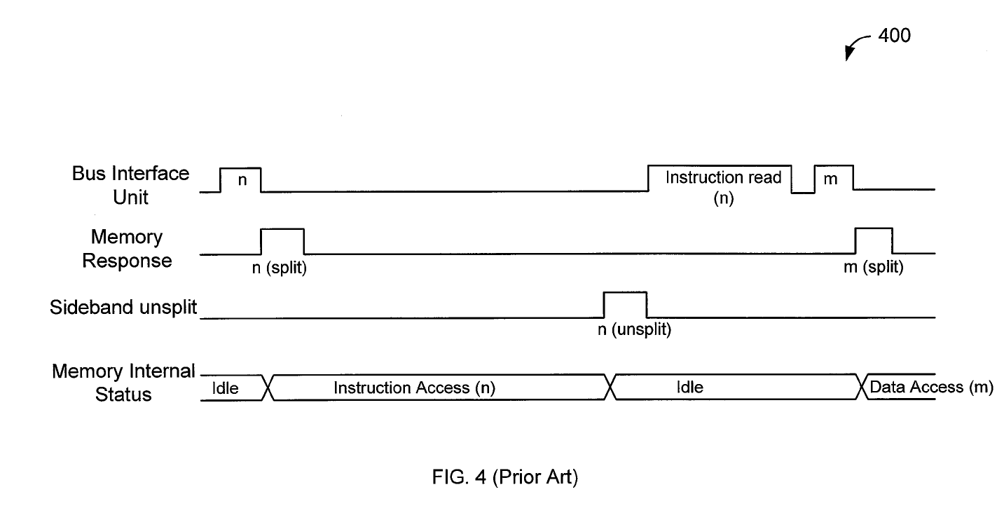

The system bus 308 can represent a system bus conforming to a specification supporting split transactions. As is depicted by the timing diagram of FIG. 4 and known in the art, after a request n is submitted by a requesting bus master and communicated through a bus interface unit via the system bus to a slave device (such as memory or peripherals), the slave device can respond to the request with a “split” control signal to designate that the transaction will be split and to cause the system bus arbiter to allow other bus masters to have access to the system bus. When the slave device has completed the servicing of the request and is ready to deliver a response to the requesting bus master, an “unsplit” control signal is communicated to the system bus arbiter and the requesting bus master informing both that the transaction is ready to be completed. This “unsplit” signal can be communicated via a sideband channel, however, it would be apparent to one of ordinary skill in the art that an “unsplit” signal can be communicated to the system bus arbiter and the requesting bus master in other ways.

However, as is depicted in FIG. 4, two consecutive memory requests n and m submitted by a processor with a single bus interface unit can result in memory idle time, as shown by Memory Internal Status. As is known in the art, the time required by the memory for fetching and writing data can be a bottleneck that causes core pipeline stalling in a processor because the processor's core pipeline stages can complete an operation quicker if data required by a core pipeline stage resides in a processor's cache instead of being fetched from the memory.

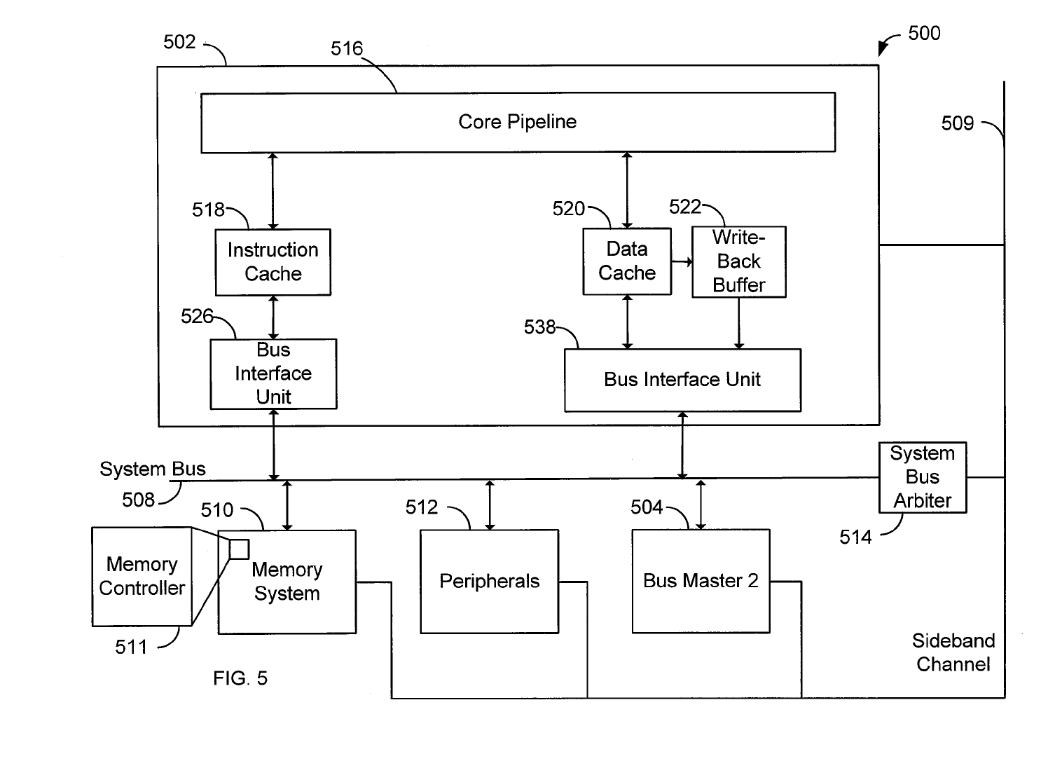

FIG. 5 depicts a functional block diagram of an exemplary embodiment 500 according to the disclosure. A processor 502, a memory system 510, other bus masters 504, peripherals 512, and system bus arbiter 514 are coupled to a system bus 508, the system bus facilitating communication between the components of the system 500. The memory system 510 stores data and instructions that may be required by the processor 502 and other components of the system 500. The memory system 510 also allows the processor 502 and other components of the computer system 500 to store or write data to the memory 510 memory system 510 via requests submitted to the memory controller 511. As is known, a memory controller 511 can receive requests on behalf of the memory system 510 and handle such requests to access the memory system 510. The processor 502 includes a core pipeline 516, which performs tasks within the processor 502 including but not limited to: fetching instructions, decoding instructions, executing instructions, reading memory and writing memory. The processor's core pipeline 516 communicates with an instruction cache 518, a data cache 520 and a write-back buffer 522. The instruction cache 518 retains a cache of instructions for high-speed delivery to the core pipeline 516. As is known in the art, an instruction cache 518 can retain a cache of recently fetched instructions or apply predictive algorithms to fetch and store frequently requested instructions or predict instructions that will be requested in the future by the core pipeline 516. The instruction cache 518, however, does not generally store all instructions that may be requested by the core pipeline 516. If the core pipeline 516 requests an instruction that is not contained in the instruction cache 518, the instruction cache 518 will request that instruction from the memory system 510 via the first bus interface unit 526.

Each depicted component can be further coupled to a sideband channel 509, which can be used to communicate various control signals between the depicted components coupled to the system bus 508. For example, a “split” or an “unsplit” signal can be transmitted on the sideband channel 509 so that it is not necessary to occupy the system bus 508 during the transmission of such a signal.

The data cache 520 retains a cache of data that is in the memory system 510 for high-speed delivery to the core pipeline 516. The data cache 520, however, does not generally store all of the data that may be requested by the core pipeline 516. If the core pipeline 516 requests data that is not contained in the data cache 520, the data cache 520 will request that data from the memory system 510 via the second bus interface unit 538.

The data cache 520 can also submit a request to write data to the memory system 510 that is delivered by the core pipeline to the write-back buffer 522. The write-back buffer 522 retains the requests to write to the memory system 510 generated by the core pipeline 516 and delivers the requests when appropriate. The write-back buffer 522 can use methods or algorithms known in the art for efficiently buffering and sending requests through the second bus interface unit 538 to write to the memory system 510. The write-back buffer 522 also communicates with the data cache 520, which delivers core pipeline 516 requests to write data to the memory system 510 via the second bus interface unit 538.

The system bus arbiter 514 arbitrates access to the system bus 508 and determines when it is appropriate for a system bus master to read or write data to the system bus 508. As noted above, if the system bus 508 conforms to a specification that does not allow more than one split transaction for each bus master residing on the system bus, such as the AHB specification, fetching and writing of data from the memory system 510 can cause pipeline stalling of the core pipeline 516, which can degrade system performance. By employing a first bus interface unit 526 and a second bus interface unit 538, a processor 502 in accordance with the disclosure can effectively appear to the system bus 508 and system bus arbiter 514 as more than one bus master on the system bus 508. Consequently, because a processor 502 in accordance with the disclosure exists as more than one bus master on the system bus 508, the processor 502 can initiate more than one concurrent split transaction, which can reduce the effect of pipeline stalling, reduce memory idle time and increase the performance of the computer system.

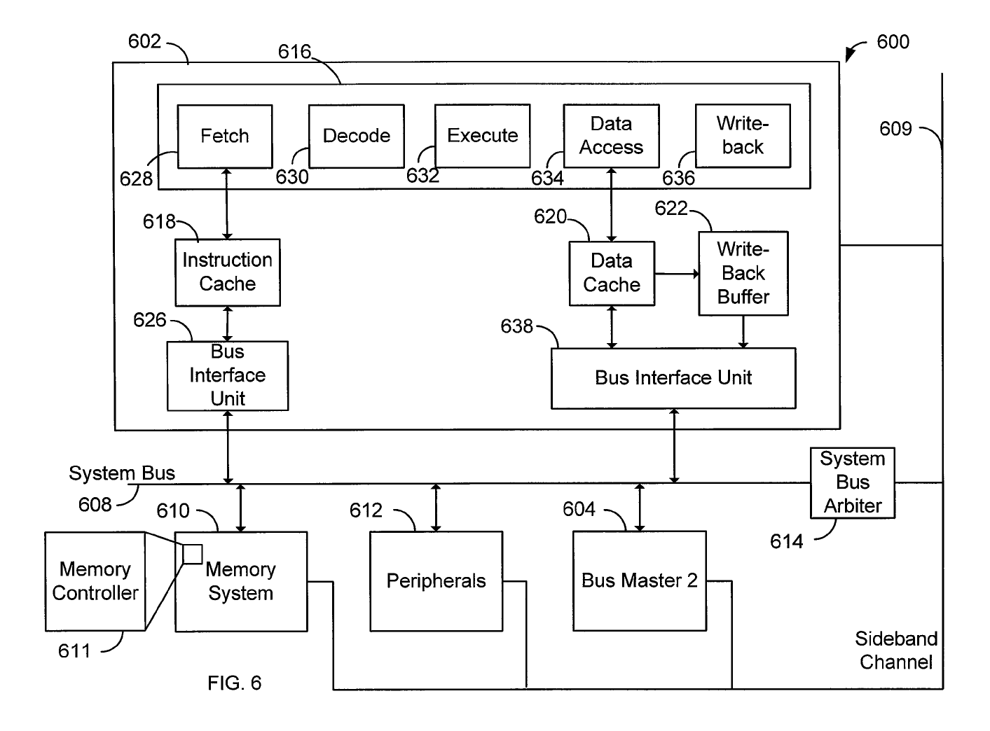

FIG. 6 depicts a functional block diagram of the exemplary embodiment 600 of FIG. 5 in accordance with the disclosure. FIG. 6 further depicts an exploded view of the processor's core pipeline 616. This exemplary embodiment 600 includes a processor 602 with fetch 628, decode 630, execute 632, data-access 634, and write-back 636 pipeline stages. The fetch pipeline stage 628 is coupled to an instruction cache 618, which retains a cache of instructions requested by the fetch pipeline stage 628. The instruction cache 618 retains a cache of instructions for high-speed delivery to the core pipeline 616. As is known in the art, the instruction cache 618 can retain a cache of recently fetched instructions or apply predictive algorithms to fetch and store frequently requested instructions or predict instructions that will be requested by the fetch pipeline stage 628. The instruction cache 618, however, does not generally store all instructions that may be requested by the core pipeline 616. If the fetch pipeline stage 628 requests an instruction that is not contained in the instruction cache 618, the instruction cache 618 will request the instruction from the memory system 610 via the first bus interface unit 626. Further, each depicted component can be further coupled to a sideband channel 609, which can be used to communicate various control signals between the depicted components coupled to the system bus 608. For example, a “split” or an “unsplit” signal can be transmitted on the sideband channel 609 so that it is not necessary to occupy the system bus 608 during the transmission of such a signal.

The data-access pipeline stage 634 is coupled to a data cache 620, which retains a cache of data requested by the data-access pipeline stage 634. The data cache 620 retains a cache of data in the memory system 610 for high-speed delivery to the data-access pipeline stage 634. The data cache 620 is coupled to a second bus interface unit 638, which is coupled to the system bus 608. The second bus interface 638 unit communicates with components in the computer system coupled to the system bus 608 on behalf of the data cache 620. The data cache 620, however, does not generally store all of the data that may be requested by the data-access pipeline stage 634. If the data-access pipeline stage 634 requests data that is not contained in the data cache 620, the data cache 620 will request data from the memory system 610 or peripherals 612 via the second bus interface unit 638.

The data cache 620 is configured to update data contained within the data cache 620 if the core pipeline requests to overwrite data in memory system 610 that is also residing in the data cache 620. This allows the data cache 620 to eliminate the need for re-requesting data it is already caching from the memory system 610 simply because the core pipeline has submitted a request to update the data in the memory system 610.

The data cache 620 is also coupled to a write-back buffer 622, which retains a cache or buffer of data that the data-access pipeline stage 634 requests to write to the memory system 610. The write-back buffer 622 is also coupled to the second bus interface unit 638, which is coupled to the system bus 608. The write-back buffer 622 retains the requests to write to the memory generated by the data cache 620 and delivers the requests when appropriate to the memory system 610 via the second bus interface unit 638 and the system bus 608. The write-back buffer 622 can use methods or algorithms known in the art for efficiently buffering and sending requests to write to the memory system 610.

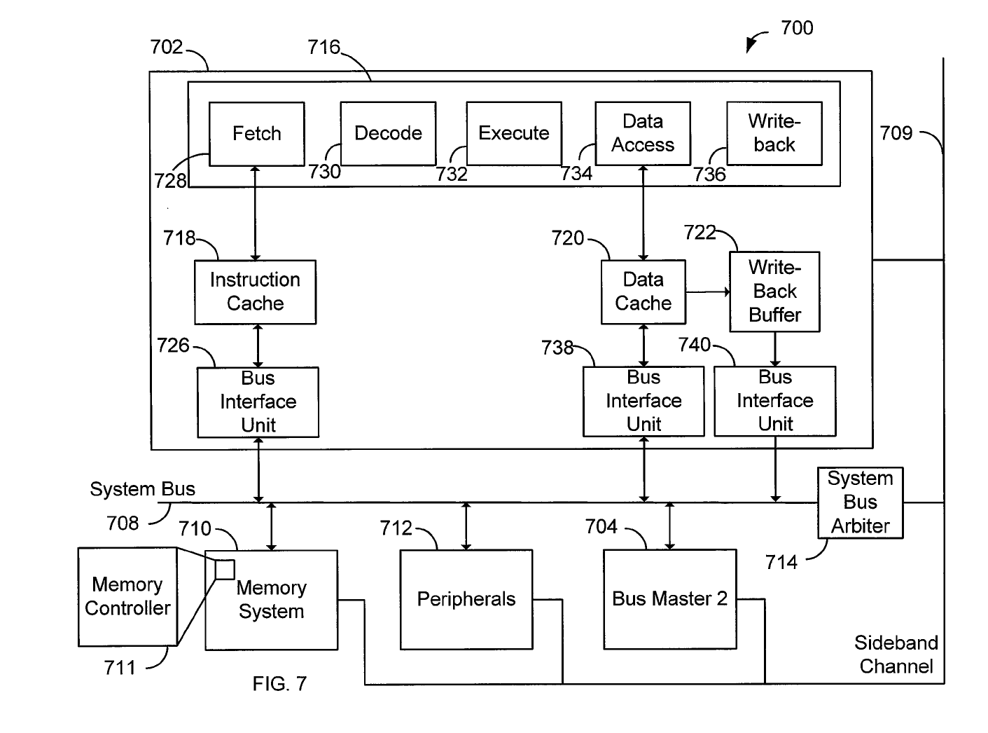

FIG. 7 depicts a functional block diagram of an alternative exemplary embodiment 700 according to the disclosure. A processor 702, a memory system 710, other bus masters 704, peripherals 712, and system bus arbiter 714 are coupled to the system bus 708, the system bus 708 facilitating communication between the components of the system 700. The memory system 710 stores data and instructions that may be required by the processor 702 and other components of the computer system. The memory system 710 also allows the processor and other components of the computer system to store or write data to the memory system 710. The processor 702 includes a core pipeline 716, which performs tasks within the processor 702 including but not limited to: fetching instructions, decoding instructions, executing instructions, reading memory and writing memory. In the exemplary embodiment of FIG. 7, the core pipeline 716 includes a fetch 728, decode 730, execute 732, data-access 734 and write-back 736 stages. The processor's core pipeline stages communicate with an instruction cache 718, a data cache 720 and a write-back buffer 722.

The fetch pipeline stage 728 is coupled to the instruction cache 718, which retains a cache of instructions for high-speed delivery to the fetch pipeline stage 728. As is known in the art, the instruction cache 718 can retain a cache of recently fetched instructions or apply algorithms to fetch and store frequently requested instructions or predict instructions that will be requested by the fetch pipeline stage 728. The instruction cache 718, however, does not generally store all instructions that may be requested by the core pipeline 716. If the fetch pipeline stage 728 requests an instruction that is not contained in the instruction cache 718, the instruction cache 718 will request the instruction from the memory system 710 via the first bus interface unit 726.

The data-access pipeline stage 734 is coupled to a data cache 720, which retains a cache of data requested by the data-access pipeline stage 734. The data cache 720 retains a cache of data in the memory system 710 for high-speed delivery to the core pipeline 716. The data cache 720 is coupled to a second bus interface unit 738, which is coupled to the system bus 708. The second bus interface unit 738 communicates with components in the computer system coupled to the system bus 708 on behalf of the data cache 720. The data cache 720, however, does not generally store all of the data that may be requested by the data-access pipeline stage 734. If the data-access pipeline stage 734 requests data that is not contained in the data cache 720, the data cache 720 will request data from the memory system 710 or peripherals 712 via the second bus interface unit 738.

The data cache 720 is coupled to a write-back buffer 722, which retains a cache or buffer of write data that the data-access pipeline stage 734 requests to write to the memory system 710. The write-back buffer 722 is also coupled to a third bus interface unit 740, which is coupled to the system bus 708. The third bus interface unit 740 communicates with components of the computer system also coupled to the system bus 708 on behalf of the write-back buffer 722. The write-back buffer retains write requests from the data-access pipeline stage 734 and delivers them to the memory system 710 when appropriate via the third bus interface unit 740. The write-back buffer 722 can use methods or algorithms known in the art for efficiently buffering and sending requests to write to the memory system 710.

The system bus arbiter 714 arbitrates access to the system bus 708 and determines when it is appropriate for a system bus master to read or write data to the system bus 708. As previously noted, if the system bus 708 conforms to a specification that does not allow more than one split transaction for each bus master residing on the system bus, such as the AHB specification, the memory's 710 fetching and writing of data can cause pipeline stalling of the core pipeline 716, which can degrade system performance. By employing a first bus interface unit 726, a second bus interface unit 738 and a third bus interface unit 740, a processor in accordance with the disclosure can effectively appear to the system bus 708 and system bus arbiter 714 as more than one bus master on the system bus 708. Consequently, because a processor 702 in accordance with the disclosure can effectively appear as three bus masters on the system bus 708, the processor 702 can initiate at least three concurrent split transactions, which can reduce the effect of pipeline stalling, reduce memory idle time and increase the performance of the computer system. Further, each depicted component can be further coupled to a sideband channel 709, which can be used to communicate various control signals between the depicted components coupled to the system bus 708. For example, a “split” or an “unsplit” signal can be transmitted on the sideband channel 709 so that it is not necessary to occupy the system bus 708 during the transmission of such a signal.

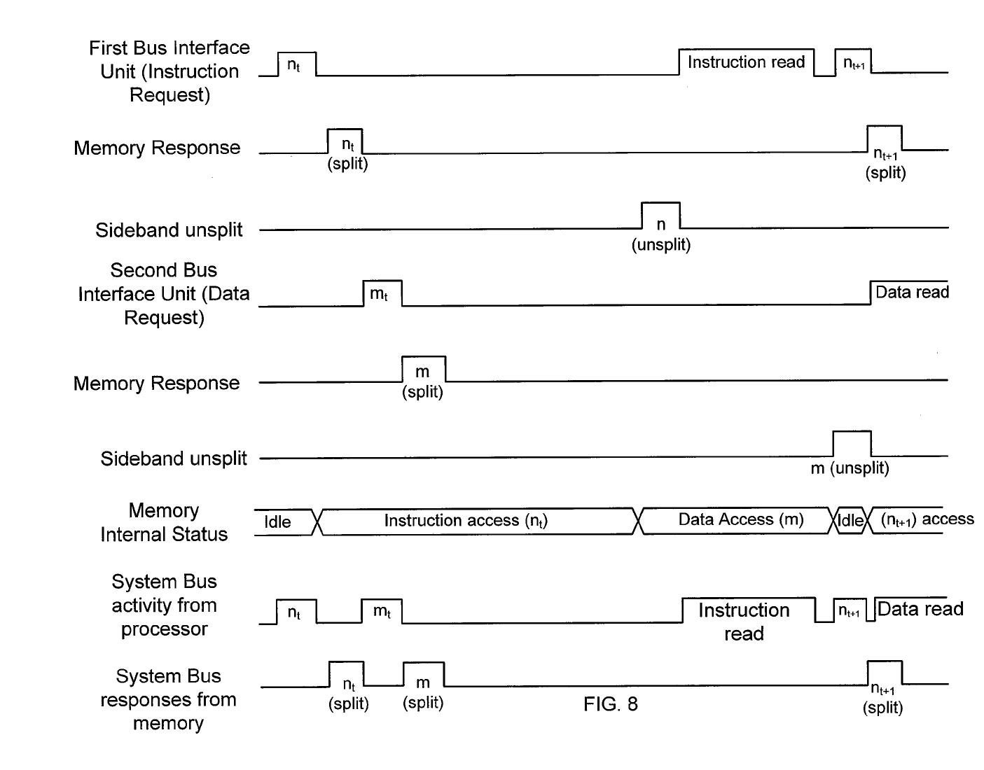

FIG. 8 depicts a timing diagram illustrating the operation of components on the system bus, including the processor, memory, system bus arbiter, and sideband communication channels. FIG. 8 illustrates the increased efficiency and system performance of an embodiment in accordance with the disclosure. Two consecutive memory requests nₜ and m are depicted as in FIG. 4; however, FIG. 8 Memory Internal Status shows that idle time of the memory is reduced and the memory begins to service the second submitted request before the servicing of the first request has completed, resulting in a more efficient use of the memory. The System Bus activity from processor shows the activity on the system bus initiated by the processor's memory requests. The System Bus response from memory shows how the processor can now engage in more than one split transaction with the memory.

Memory Internal Status illustrates that, for example, the memory can begin the servicing of a data request before an instruction request has completed. The memory begins to access data requested by a data request m immediately after it has accessed a requested instruction for instruction request nₜ. The access of requested data occurs while the previously requested instruction is being read by the requesting bus interface unit. Subsequently, the memory can service a next instruction request while the data accessed in response to the data request is read by the requesting bus interface unit. This overlapping of processor memory requests results in improved performance and reduced memory idle time.

1. A system for sending and receiving data to and from a processor, comprising:
a processor having a first processor bus interface unit in communication with a system bus and a second processor bus interface unit in communication with the system bus;
a system bus arbiter in communication with the system bus, the system bus arbiter configured to arbitrate access to the system bus; and
a memory system in communication with the system bus, wherein the first processor bus interface unit and the second processor bus interface unit are configured to submit requests to a memory controller, wherein the memory controller can service a first request from a first processor bus interface unit and a second request from a second processor bus interface unit, the memory controller configured to begin to service the second request before servicing of the first request has completed.

2. The system of claim 1, wherein the first processor bus interface unit submits requests to fetch instructions from the memory system.

3. The system of claim 1, wherein the second processor bus interface unit submits requests to retrieve data from the memory system and requests to write data to the memory system.

4. The system of claim 1, wherein the system bus conforms to the Advanced High-Performance Bus specification.

5. The system of claim 1, further comprising:
a sideband channel configured to transmit control signals to the processor and the system bus arbiter, wherein the control signals alert the processor and the system bus arbiter when the system bus is available for at least one of: reading data from the system bus and writing data from the system bus.

6. The system of claim 1, further comprising:
a third processor bus interface unit in communication with the system bus, wherein the memory system can begin to service a third request from a third processor bus interface unit before completing the processing of the first request and the second request.

7. The system of claim 6, wherein the third processor bus interface unit submits requests to write data to the memory system.

8. A method for sending and receiving data between a processor and a system bus, comprising the steps of:
submitting a first request to the system bus via a first processor bus interface unit; and
submitting a second request to the system bus via a second processor bus interface unit.

9. The method of claim 8, further comprising submitting the second request before the completion of the servicing of the first request.

10. The method of claim 8, further comprising:
beginning processing of the second request before processing of the first request has completed.

11. The method of claim 8, wherein the first request and the second request traverse the system bus to a memory system and comprise requests to read data from or write data to the memory system.

12. The method of claim 8, further comprising submitting a third request to the system bus via a third processor bus interface unit; and
beginning processing of the third request before processing of the second request has completed.

13. The method of claim 12, wherein the first request, the second request and the third request traverse the system bus to a memory system and include requests chosen from: requests to read data from the memory system and requests to write data to the memory system.

14. A computer processor, comprising:
a processor configured with a core pipeline having at least an instruction fetch stage, a data access stage, and a data write-back stage;
a first bus interface unit configured to fetch instructions from a memory system for the instruction fetch stage; and
a second bus interface unit configured to access the memory system for the data access stage.

15. The computer processor of claim 14, further comprising:
a third bus interface unit configured to access the memory system for the data access stage, wherein the second bus interface unit is configured to read data from the memory system for the data access stage and the third bus interface unit is configured to write data to the memory system for the data access stage.

16. The computer processor of claim 14, wherein the first bus interface unit and the second bus interface unit are coupled to a system bus and are configured to communicate with the memory system via the system bus.

17. The computer processor of claim 16, wherein the first bus interface unit, the second bus interface unit and the third bus interface unit are coupled to a system bus and are configured to communicate with the memory system via the system bus.

18. The computer processor of claim 16, further comprising:
an instruction cache coupled to the instruction fetch stage, the instruction cache configured to retain a cache of instructions for delivery to the instruction fetch stage and to request instructions from the memory system on behalf of the instruction fetch stage via the first bus interface unit and the system bus.

19. The computer processor of claim 16, further comprising:
a data cache coupled to the data access stage, the data cache configured to retain a cache of data for delivery to the data access stage and to request data from the memory system on behalf of the data access stage via the second bus interface unit and the system bus.

20. The computer processor of claim 19, further comprising:
a write-back buffer coupled to the data cache, the write-back buffer configured to buffer requests on behalf of the data access stage to write data to the memory system and to send requests to write data to the memory system via at least one of: the second bus interface unit and the system bus and the third bus interface unit and the system bus.
